(19) United States
(12) Patent Application Publication
(10) Pub. No.: US 2013/0108766 A1
(43) Pub. Date: May 2, 2013

(54) GRIT CHIPS

(71) Applicants: Nancy Ann Taylor, Lawrenceville, GA (US); Alana Diane Taylor, Roswell, GA (US)

(72) Inventors: Nancy Ann Taylor, Lawrenceville, GA (US); Alana Diane Taylor, Roswell, GA (US)

(21) Appl. No.: 13/665,056

(22) Filed: Oct. 31, 2012

Related U.S. Application Data
(60) Provisional application No. 61/553,342, filed on Oct. 31, 2011.

(51) Int. Cl. A23L 1/164

(52) U.S. Cl. 426/560; 426/439

(57) ABSTRACT

A grit chip 10 is made from a hominy flour 6 in combination with quick grits 7. The chip 10 is formed flat into thin sheets either rolled or pressed, cut into small rectangular shapes of a width of ¾ inches or greater and a length at least 3 times the width, preferably 4 or more times the width and then either deep fried after being cut in preferably peanut oil, drained and lightly salted and packaged or instead the cut rectangular chips can be flash frozen and packaged to be fried at the restaurant or home. The grit chip 10 when fried achieves a golden rather smooth textured surface 11 with edges 20, 21, 22 and 23 that are curled causing the rectangular shape to achieve a subtle three dimensional appearance.

### RELATED APPLICATIONS

This application claims benefit of priority to U.S. Provisional Application Ser. No. 61/553,342 filed on Oct. 31, 2011 entitled “Grit Chips”.

### TECHNICAL FIELD

This invention relates to a snack chip with a unique shape and texture and a method of manufacture that can include pre-packaged chips or alternatively flash frozen chips fried later at time of use.

### BACKGROUND OF THE INVENTION

The invention of the potato chip was one of the most successful snack foods ever created. The thin cut, fried and lightly salted chip has been the subject of many different and unique processes and recipes. Many with unique flavoring and spices applied to achieve a distinctive taste.

Some early establishments have freshly made potato chips fried on site to provide a signature style to this well-known chip product which is cut as a thin oval sliced from the potato. Similarly, Mexican restaurants are recognized for a hearty sampling of tortilla chips and salsa, both of which can be pre-packaged or made on site. The tortilla chip, typically made from corn based flour, is of a generally triangular shape or sometimes round which is also deep fried.

The desire to provide great tasting chips drives the snack food industry.

The present invention describes a method and a chip made of a distinctly different shape and unique base ingredients that achieve a distinctive taste and texture uniquely different from a conventional tortilla or potato chip.

### SUMMARY OF THE INVENTION

A grit chip is made from a hominy flour in combination with quick grits. The chip is formed flat into thin sheets either rolled or pressed, cut into small rectangular shapes of a width of ¾ inches or greater and a length at least 3 times the width, preferably 4 or more times the width and then either deep fried after being cut in preferably peanut oil, drained and lightly salted and packaged or instead the cut rectangular chips can be flash frozen and packaged to be fried at the restaurant or home.

The grit chip when fried achieves a golden rather smooth textured product with edges that are curled causing the rectangular shape to achieve a subtle three dimensional appearance. This curling also avoids the chip structure remaining flat instead creates a slight curvature or wavy bowing. This importantly strengthens the chip making it more suitable for dipping.

This curled rectangular shape makes it easy to grip for eating generally and more particularly for dips.

The thickness of the grit chip can be varied to as thin as a potato chip or slightly thicker if so desired, however, the thinner grit chips are believed preferable so as to be more favorably compared to a potato chip.

### DEFINITIONS

As used herein and in the claims:

“flour” is a powder made from grinding cereal grains, other seeds or roots.

“hominy” is corn that has been processed to remove the hull and germ. When ground hominy is often called grits.

“grits” is coarsely ground corn or sometimes hominy.

“quick grits” generally refers to unbleached white hominy milled finer than regular grits.

### BRIEF DESCRIPTION OF THE DRAWINGS

The invention will be described by way of example and with reference to the accompanying drawings in which:

FIG. 1 is a perspective top view of a grit chip of the present invention.

FIG. 2 is a perspective bottom view of a grit chip of the present invention.

FIG. 3 is a top view of a grit chip.

FIG. 4 is a bottom view of a grit chip.

FIG. 5 is a side view showing a curled edge of the chip along its length.

FIG. 6 is the opposite side view showing a curled edge of the chip along its length.

FIG. 7 is an end view showing an end of the chip across its width.

FIG. 8 is an opposite end view showing an end of the chip across its width.

### DETAILED DESCRIPTION OF THE INVENTION

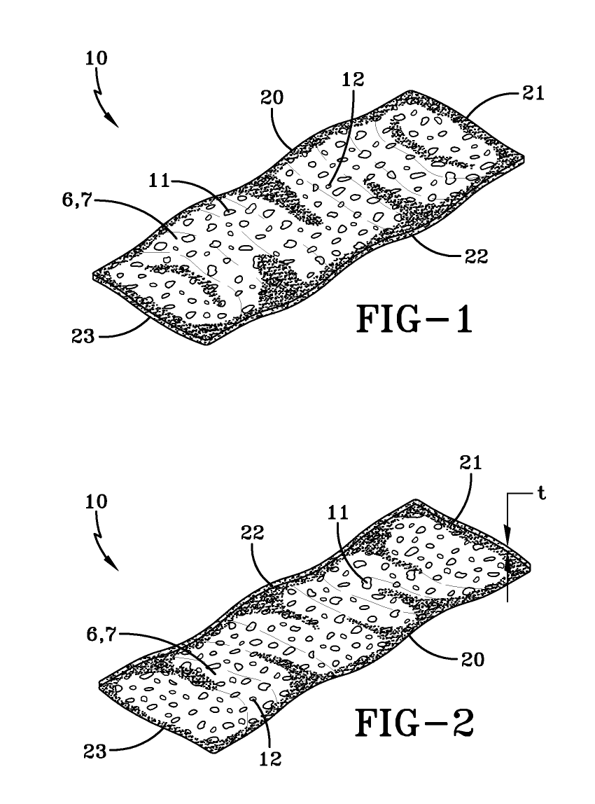

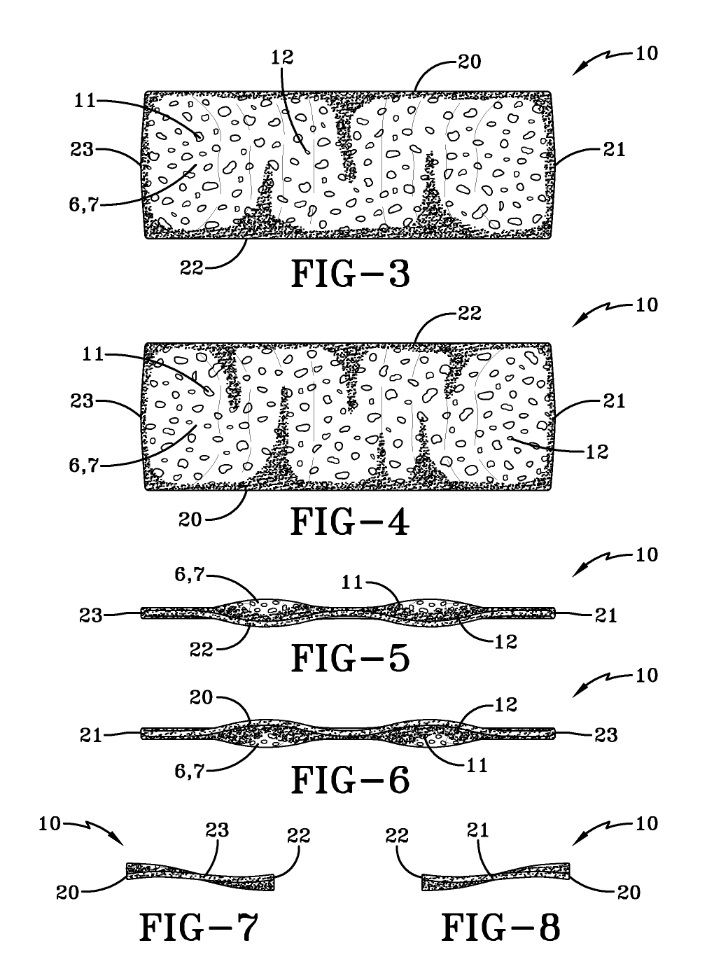

With reference to FIGS. 1-4, a rectangular grit chip 10 is shown. The grit chip 10 is prepared by using hominy flour 6, quick grits 7 as the dry ingredients to which water is added and mixed to form a dough. The dough mixture is tacky and to press or roll flat the dough is placed in between two plastic sheets and rolled flat using a pin or a press. Once flattened, the grit chips 10 are cut into strips of rectangular shape. The grit chip 10 preferably is deep fried in peanut oil. The peanut oil is preferred because it maintains its cooking properties longer than other cooking oils.

The cut grit chip 10 when placed in the oil at 325 degrees Fahrenheit will float until saturated then it sinks and must be removed and drained of excess oil. If fried in this manner the grit chip 10 will have a golden toasted appearance where it can be sprinkled with salt 12 and packaged in bags similar to potato chips.

It is important that the chip 10 be processed shortly after the dough is made and pressed. The dough can sit a few hours, but prolonged waiting can cause the chip dough to react with the air to ruin the batch. In practice, it has been discovered the chip, if delayed in frying, will darken in a burnt looking appearance even though the same frying procedures were otherwise followed. One solution to this problem was using individual quick freezing of the unfried rectangular cut dough. This basically allows the unfried grit chips to be packaged and shipped frozen to fine restaurants for frying the product at the eatery.

Most consumers, however, may prefer the chips to be fried and packaged and shipped to the store for immediate consumption. In those cases the chip 10 is ready to eat when shipped.

The frying is preferably done at 325 degrees F. Higher temperatures can be tried, but care must be taken not to burn the chip. 325 degrees F. is actually considered a moderate frying temperature. The resultant grit chip 10 has a thin golden appearance with a surface texture 11 mimicking the surface of a potato chip. This surface texture 11 is achieved by the use of hominy flour 6 which is finely ground and quick grits 7 which are small in size adapted for fast, quick cooking The granular particle size is small allowing the texture to achieve a smoothness otherwise difficult to duplicate.

Alternatively, stone ground grits which are coarse and grainy can be substituted to achieve a different more grainy texture.

The grit chip 10 is made from a hominy flour 6 in combination with quick grits 7. The chip 10 is formed flat into thin sheets either rolled or pressed, cut into small rectangular shapes of a width of ¾ inches or greater and a length at least 3 times the width, preferably 4 or more times the width and then either deep fried after being cut in preferably peanut oil, drained and lightly salted and packaged or instead the cut rectangular chips 10 can be flash frozen and packaged to be fried at the restaurant or home.

As shown in FIGS. 1-8, the grit chip 10 when fried achieves a golden rather smooth textured surface 11 with edges 20, 21, 22, 23 that are curled causing the rectangular shape to achieve a subtle three dimensional appearance. This curling, most visible along the edges 20, 21, 22 and 23 as depicted in FIGS. 5, 6, 7 and 8, also avoids the chip structure remaining flat instead creates a slight curvature or wavy bowing. This importantly strengthens the chip 10 making it more suitable for dipping.

This curled rectangular shape makes it easy to grip for eating generally and more particularly for dips.

As shown in FIG. 2, the thickness (t) of the grit chip 10 can be varied to as thin as a potato chip or slightly thicker if so desired, however, the thinner grit chips are believed preferable so as to be more favorably compared to a potato chip. The overall size of each chip 10 can be uniform or can be varied to a random number of sizes. This can be accomplished by varying the width or the length.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. A grit chip comprises:
a rectangular grit based chip.

2. The grit chip comprises:
a salted chip, the chip being deep fried and having one or more edges slightly curled to provide a 3 dimensional appearance to the rectangular shape.

3. The grit chip of claim 1 wherein the grit chip is made of a dough mixture of hominy flour, grits and water pressed or otherwise flattened into thin sheets.

4. The grit chip of claim 3 wherein the grit is made from a finely ground quick grit.

5. The grit chip of claim 3 wherein the grit is made from a stone ground grit.

6. The grit chip of claim 2 wherein the grit chip is fried in peanut oil.

7. The grit chip of claim 1 wherein the grit chip has a width of at least ¾ inches and a length at least 3 times the width.

8. A method of making a grit chip comprises the steps of:
making a dough mixture of hominy flour, quick grits and water;
pressing or otherwise flattening the dough mixture into thin sheets;
cutting rectangular strips; and
deep frying the strips to a golden toasted color to form a rectangular shaped grit chip.
